(19) United States
(12) Patent Application Publication
(10) Pub. No.: US 2005/0232679 A1
(43) Pub. Date: Oct. 20, 2005

(54) Printer with pivotable platen

(75) Inventors: Kyoung Hwan Na, Anyang (KR); Sang Ik Nam, Seongnam (KR)

Correspondence Address: THE WEBB LAW FIRM, P.C., 700 KOPPERS BUILDING, 436 SEVENTH AVENUE, PITTSBURGH, PA, 15219, US

(73) Assignee: Korea Printing Systems Co., Ltd., Suwon (KR)

(21) Appl. No.: 11/106,745

(22) Filed: Apr. 15, 2005

(30) Foreign Application Priority Data
Apr. 16, 2004 (KR) 10-2004-26118

(51) Int. Cl. B41J 15/02; B41J 11/04; B41J 29/02

(52) U.S. Cl. 400/649; 400/611; 400/693

(57) ABSTRACT

A printer for an electronic cash register or a point of sales system includes a printer main body having a printer head, a cover frame pivotally connected to the printer main body, and a platen adjusting unit. A platen is mounted on an end of the cover frame. The platen adjusting unit is designed to allow the platen to pivot away from the printer head when the cover frame is opened, and to allow the platen to pivot close to the printer head with a predetermined gap between the platen and the printer head when the cover frame is closed.

### RELATED APPLICATION

The present application is based on, and claims priority from, Korean Patent Application Number 10-2004-0026118, filed 16 Apr., 2004, the disclosure of which is hereby incorporated by reference herein in its entirety.

### BACKGROUND OF THE INVENTION

1. Field of the Invention

The present invention relates to a printer applicable to an electronic cash register or a point of sales (POS) system, and more particularly, to a printer with a pivotable platen, which is designed to avoid a confliction between the platen and peripheral components by allowing the platen to be pivoted away from a printer head; to improve the printing quality by allowing the platen to be close to the printer head when a cover frame is closed; to easily remove a paper jammed between the printer head and the platen; and to provide convenience in use by allowing papers to be stably loaded.

2. Description of the Related Art

In an electronic cash register or a point of sales system, an impact dot print, a direct thermal printer or an inkjet printer has been generally used.

The direct thermal printer is designed to perform the printing operation by a printer head closely contacting a paper by a rubber roller. The inkjet printer is designed to perform the printing operation by spraying ink toward a platen roller. While no gap exists between the printer head and the paper in the direct thermal printer, there is a relatively wide gap between the printer head and the paper in the inkjet printer. Therefore, in the direct thermal printer and the inkjet printer, the gap variation between the printer head and the paper gives a little effect to the printing quality.

However, in the impact dot printer, a gap between the printer head and the platen is very important for the printing quality. That is, since the printing quality greatly depends on the gap variation, the printer head and the platen are assembled such that the gap therebetween can be uniformly maintained.

FIG. 1 shows a conventional impact dot printer.

As shown in FIG. 1, a conventional impact dot printer 100 is designed to perform the printing operation in a state where a paper 130 and a printing ribbon 122 are inserted between a printer head 110 and a platen 120. Since the head 110 and the platen 120 are fixed on their posts and a printing ribbon 122 is disposed between the head 110 and the platen 120, it is frequent that the insertion of the paper 130 may not be correctly realized due to a narrow gap t between the head 110 and the platen 120.

That is, the conventional impact dot printer 100 is structured such that the head 110 and the platen 120 are fixed and the paper 130 inserted through a rear end of the printer 100 passes through a path defined between the head 110 and the platen 120, in the course of which a pin 110a of the head 110 strikes the paper 130 via the ribbon 122, thereby performing the printing operation.

The head 110 and the platen 120 are adjusted to uniformly maintain the gap t between them, and fixed by a fastener 140 such as screws. When the paper is jammed between the head 110 and the platen 120, it is very difficult or inconvenient to remove the jammed paper because the ribbon 122 is also jammed between the head 110 and the platen 120.

To solve the problem, U.S. Pat. No. 5,887,999 discloses a drop and printing-type or a clamshell-type impact dot printer as shown in FIG. 2.

A dot printer 200 disclosed in the patent includes a pivotable cover frame 210. In a state where the cover frame 210 is opened, a roll-type paper 130 is loaded in a loading space 230 defined in a printer main body 220 through a drop-in method. After the paper 130 is drawn toward a printer head (not shown), the cover frame 210 is closed on the printer main body 220 and the printing operation is performed. After the printing operation is finished, the printed paper 130 is cut by blades 242 and 244 provided on the printer main body 220 and the cover frame 210.

In such a drop and printing-type or a clamshell-type impact dot printer, since the cover frame 210 is designed to rotate, when the cover frame 210 is opened, it becomes easy to load the roll-type paper 130 in the loading space 230 provided in the printer 200 from an upside. In addition, when there is a paper jam between the head (not shown) and the platen (not shown), the jammed paper can be easily removed.

However, since the platen is integrally fixed on the pivotable cover frame 210, it is frequently incurred that the paper 130 and the ribbon 122 are jammed in a narrow gap between the printer head and the platen. Furthermore, since the platen conflicts frequently with frame components, the opening/closing operation may not be effectively realized.

Since the easy paper load and easy jammed paper removal are still very important for the dot printer when considering the use and management of the printer, there is still problems in the drop and printing-type or clamshell-type impact dot printer.

U.S. Pat. No. 6,345,782 discloses an inkjet printer in which a platen roller is mounted on a front end of a slide frame. The slide frame is slidably connected to first and second cover frames that are designed to pivot around a pivot shaft. The platen roller is disposed facing a printer head. By the pivotal motion (the opening/closing operation) of the first and second cover frames, the slide frame and the platen roller mounted on the front end of the slide frame slides horizontally to move away from or toward the printer head. That is, the gap between the printer head and the platen roller is adjusted while the first and second cover frames are opened and closed.

The platen roller is connected to a gear driving unit so as not to rotate in an opened position of the first and second cover frames. However, the platen roller is designed to rotate in the closed position of the first and second cover frames by being engaged with a plurality of gears of the gear driving unit. As a result, the platen roller functions as a paper feeding roller allowing the paper to pass through a gap between opposing press rollers.

A structure relating to the reciprocating motion of the platen roller is very complicated, making it difficult to manufacture the same and increasing the manufacturing costs. The gap between the printer head and the platen of the inkjet printer is not strictly required as compared with that of the impact dot printer. Therefore, it is difficult to apply the structure of the inkjet printer to the impact dot printer where a ribbon is inserted between the printer head and the platen roller.

### SUMMARY OF THE INVENTION

Accordingly, the present invention is directed to a printer with a pivotable platen that substantially obviates one or more problems due to limitations and disadvantages of the related art.

An object of the present invention is to provide a printer with a pivotable platen, which is designed to easily remove a cover frame from a printer main body when it is intended to exchange a paper and to easily remove a paper jammed between the printer head and the platen by simply modifying a structure thereof.

Another object of the present invention is to provide a printer with a pivotable platen, which is designed to improve the printing quality by accurately aligning a paper and a ribbon between a printer head and a platen by allowing the paper to be stably disposed to a printing position during the paper loading operation.

Still another object of the present invention is to provide an inexpensive printer that is improved in function and quality.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided A printer for printing on a recording medium in accordance with date received from a host device, comprising: a printer main body having a printer head; a cover frame pivotally connected to the printer main body, the cover frame having an end on which a platen is mounted; a platen adjusting unit for allowing the platen to pivot away from the printer head when the cover frame is opened, and for allowing the platen to pivot close to the printer head with a predetermined gap between the platen and the printer head when the cover frame is closed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a side sectional view of a conventional impact dot printer with a fixed platen;

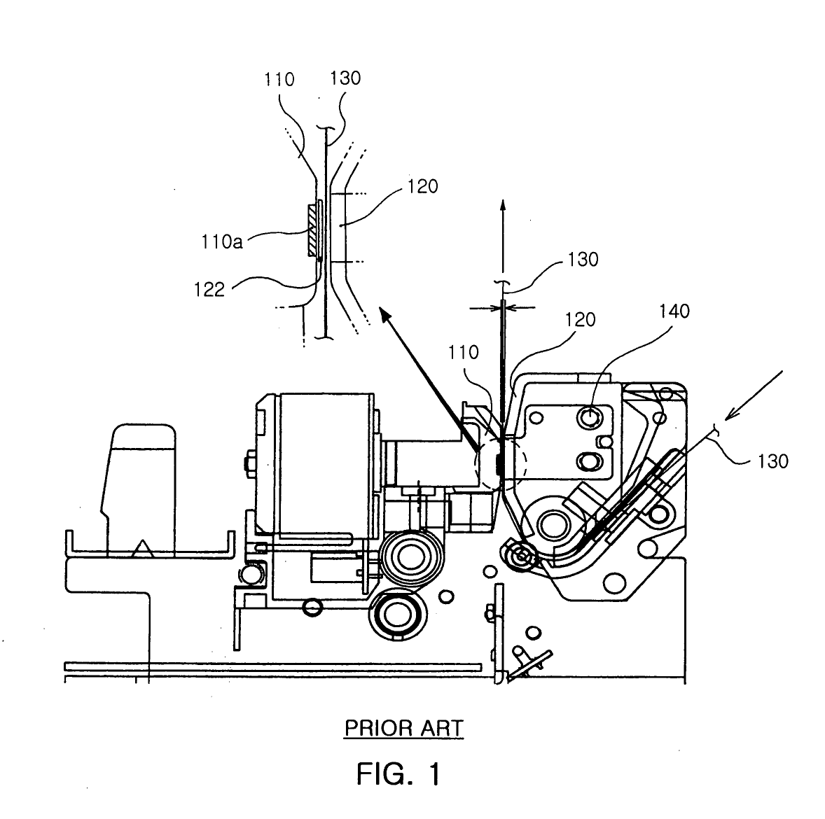

FIG. 2 is a perspective view of a conventional drop and printing-type or clamshell-type impact dot printer;

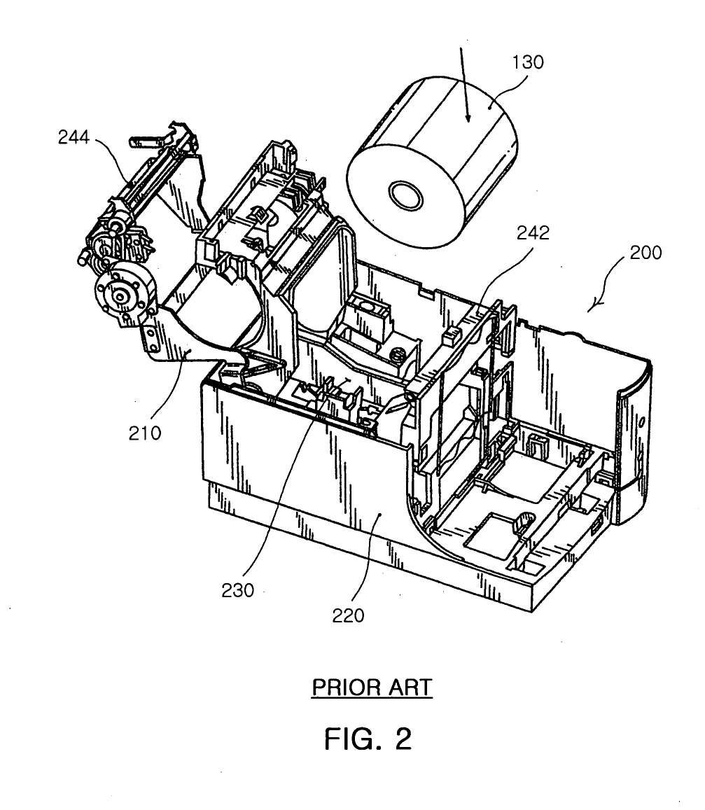

FIG. 3 is a perspective view of a printer with a pivotable platen according to an embodiment of the present invention, in which a cover is removed from the printer;

FIG. 4 is a perspective view of a printer with a pivotable platen according to an embodiment of the present invention, in which a cover is removed from the printer and a cover frame is coupled to a printer main body;

FIG. 5 is a side sectional view of a printer with a pivotable platen according to an embodiment of the present invention, in which a cover is removed from the printer and a cover frame is opened from a printer main body;

FIG. 6 is an exploded perspective view illustrating a coupling structure of a pivotable platen and a cover frame of a printer with the pivotable platen according to an embodiment of the present invention;

FIG. 7 is a view illustrating the paper loading operation in a printer with a pivotable platen according to an embodiment of the present invention; and

FIG. 8 is a view illustrating the printing operation of a printer with a pivotable platen according to an embodiment of the present invention.

### DETAILED DESCRIPTION OF THE INVENTION

Reference will now be made in detail to the preferred embodiments of the present invention, examples of which are illustrated in the accompanying drawings.

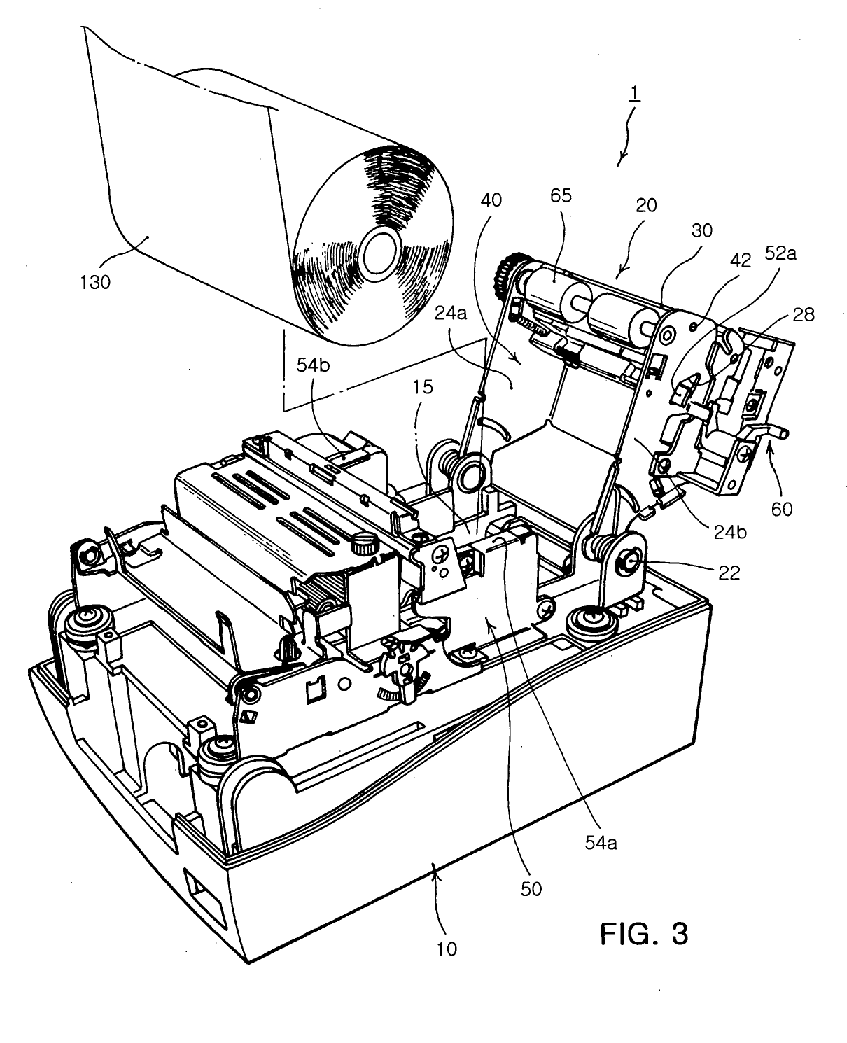

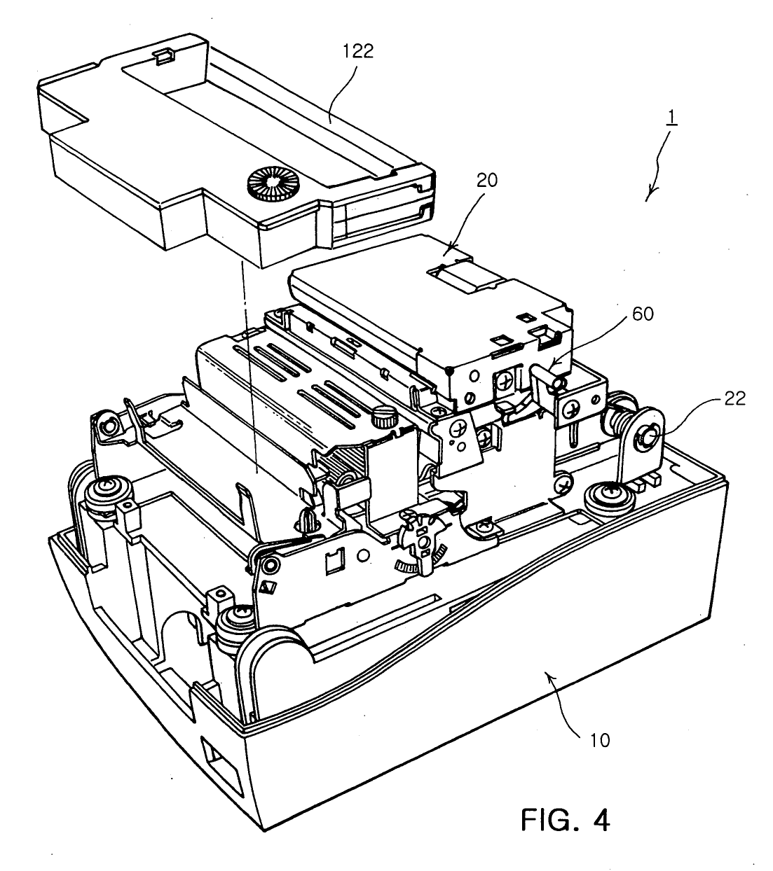

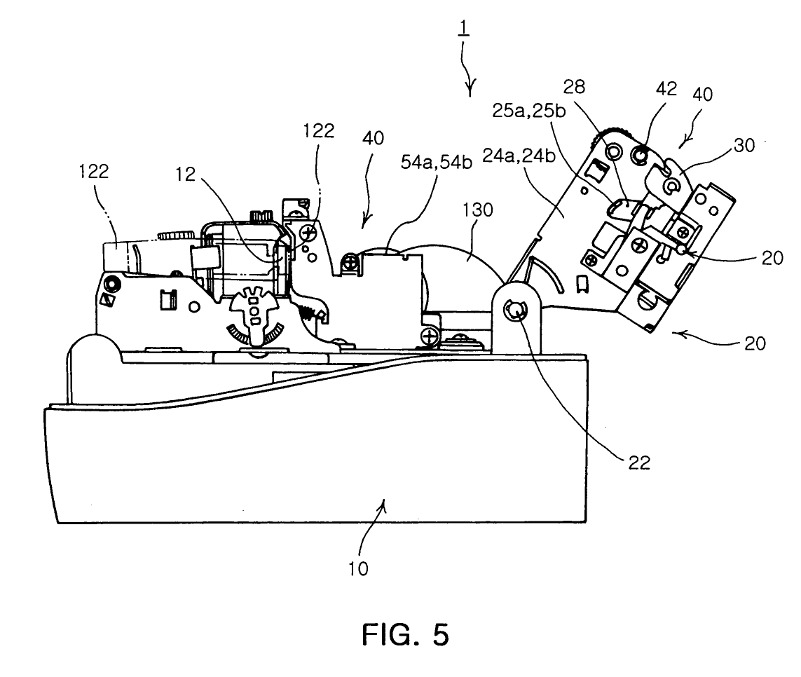

FIGS. 3 to 5 show a printer according to an embodiment of the present invention. The inventive printer is exampled as a dot printer, and may be applied to an electronic cash register or a point of sales system and formed in a drop and printing type or a clamshell type where a roll type paper 130 can be easily loaded in a printer main body 10. However, the dot printer that will be described in this embodiment is exemplary only. That is, a feature of the present invention is applied to not only such a dot printer 1 but also other types of printers such as an inkjet printer and the like.

FIGS. 3 to 5 show an internal structure of the inventive dot printer 1 by eliminating a cover.

The dot printer 1 is designed to load the paper 130 in a loading space 15 of the printer main body 10 after a cover frame 20 is opened. A printer head 12 is formed on a central upper portion of the printer main body 10 and a ribbon 122 is provided enclosing the printer head 12.

The cover frame 20 has a rear end that is pivotally connected to the printer main body 10 by a hinge 22 so as to be opened and closed by a vertical pivotal motion. A platen 30 is mounted on a front end of the printer main body 10.

When the cover frame 20 is closed, a predetermined gap is defined between the platen 30 and the printer head 12. The ribbon 122 is disposed between the platen 30 and the printer head 12. A paper path through which the paper 130 passes is defined between the platen 30 and the ribbon 122. The platen 30 functions to support the paper in the course of the printing operation performed by a pin 12a of the printer head 12 via the ribbon 122.

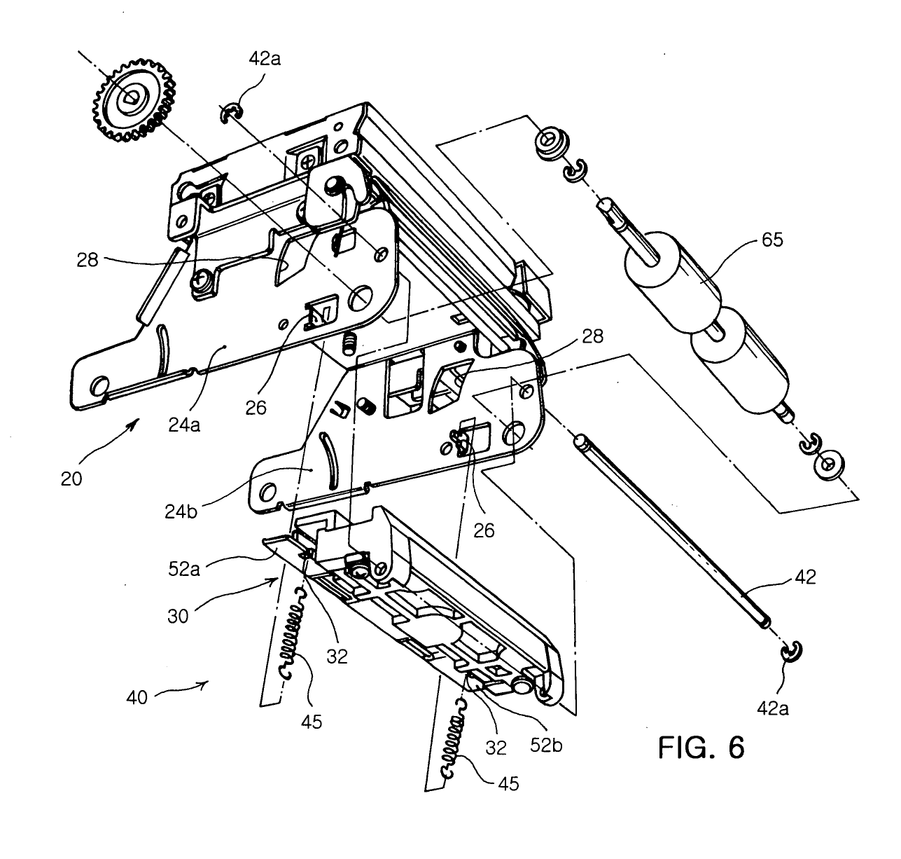

According to a feature of the present invention, a platen adjusting unit 40 is provided for adjusting a pivotal motion of the platen 30. As shown in FIG. 6, the platen adjusting unit 40 includes a pivot shaft 42 pivotally fixing a front lower portion of the platen 30 on the cover frame 20, an elastic member 45 biasing a rear portion of the platen 30 downward to allow the platen 30 to pivot around the pivot shaft 42, and a gap maintaining unit 50 biasing the rear portion of the platen 40 upward to maintain a predetermined gap T between the platen 30 and the printer head 12.

The pivot shaft 42 is horizontally inserted through the front lower portion of the platen 30, and the platen 30 is designed having a “ [symbol] ”-shaped side section.

The platen 30 may be formed of metal. A plate member 36 formed of metal may be formed on a front surface of the platen 30, which faces the head 12, through an insert injection molding process. The pivot shaft 42 is inserted through a lower portion of the plate member 36. Opposite ends of the pivot shaft 42 penetrate through both sidewalls 24a and 24b of the cover frame 20 and locks 42a are fitted around opposite end portions of the pivot shaft 42 to fix the pivot shaft 42. Therefore, the platen 30 is to be pivotally connected to the cover frame 20 around the pivot shaft 42.

The elastic member 45 biasing the rear portion of the platen 30 downward is formed of a plurality of elastic springs that are vertically disposed at both sides of the platen 30. Upper ends of the springs are hooked on respective rear projections 32 of the platen 30 and lower ends of the springs are hooked on respective projections 26 provided on the both sidewalls 24a and 24b of the cover frame 20. As a result, the rear portion of the platen 30 is biased downward around the pivot shaft 42 unless outer force is applied.

The gap maintaining unit 50 includes a pair of supporting members 52a and 52b that are projected sideward at a rear portion of the platen 30 and inserted through cutting slits 28 provided on the sidewalls 24a and 24b of the cover frame 20 and a pair of base members 54a and 54b extending upward from an inner portion of the printer main body 10 to support the supporting members 52a and 52b upward.

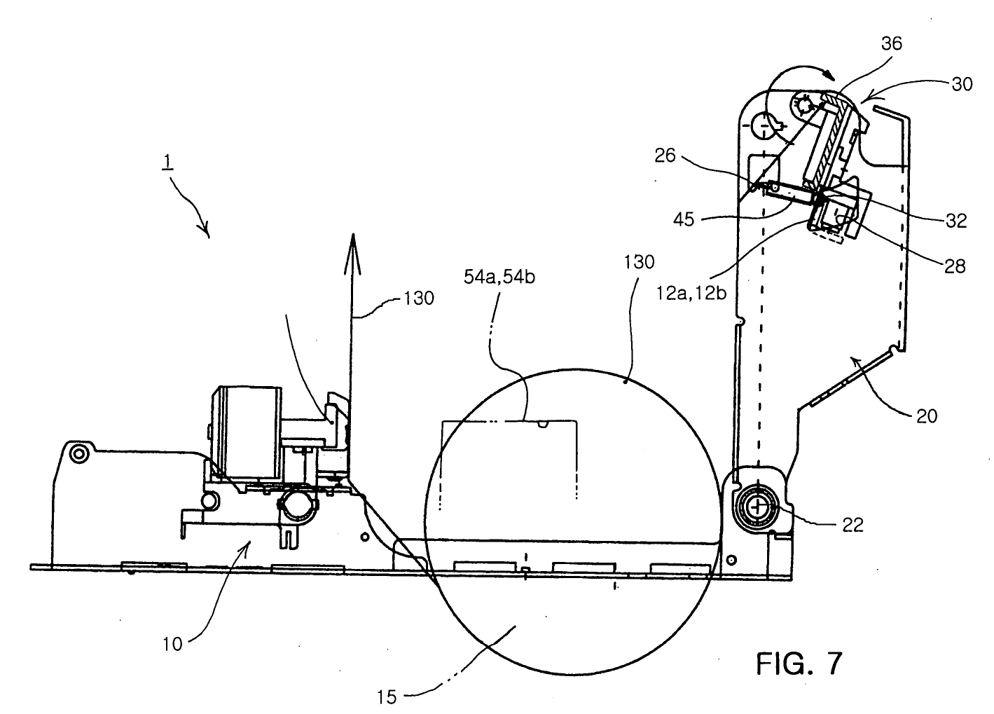

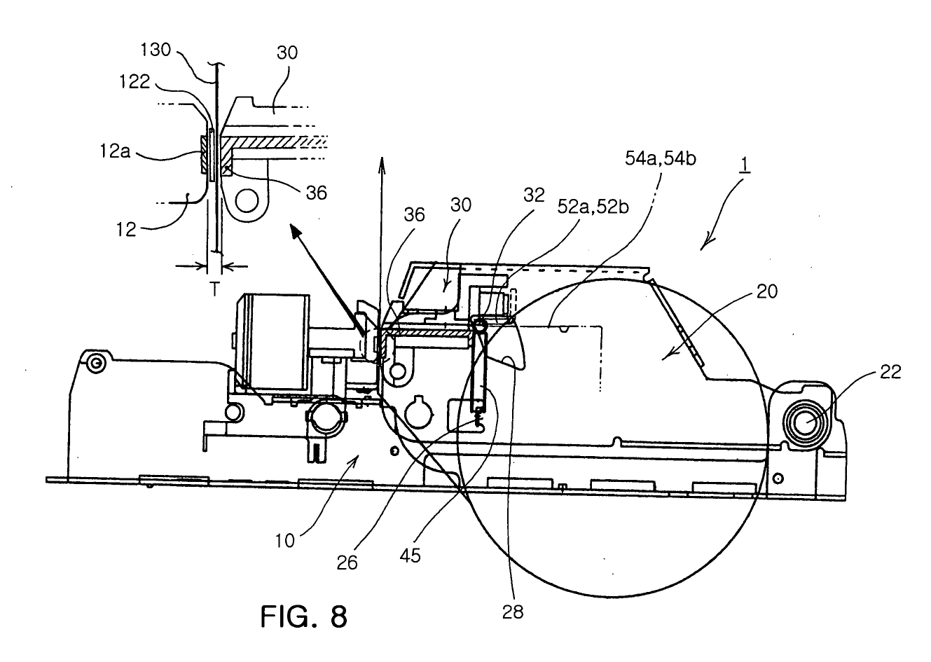

Accordingly, the supporting members 52a and 52b are located on lower portions of the respective cutting slots 28 in FIG. 7, since the rear portion of the platen 30 is biased downward by the elastic member 45. However, when the cover frame 20 is closed on the printer main body 10, the supporting members 52a and 52b projected over the cutting slits 28 of the cover frame 20 are supported upward by the base members 54a and 54b to expand the springs, thereby moving the supporting members 52a and 52b upward in the cutting slits 28 as shown in FIG. 8.

When the cover frame 20 is opened, the platen adjusting unit 40 is designed to move the rear portion of the platen downward by the elastic member 45 and to allow the front plate member 36 of the platen to pivot away from the printer head 12 around the pivot shaft 42. When the cover frame 20 is closed, the supporting members 52a and 52b of the platen 30 supported by the base members 54a and 54b move upward to allow the plate member 36 of the platen 30 to be returned by a pivotal motion, thereby allowing the plate member 36 of the platen closely approach the printer head 12 with a predetermined gap between them.

The reference numeral 60 that is not described above indicates an assembly of a locking latch and a handle that maintain the closed state of the cover frame 20 on the printer main body 10 and the reference numeral 65 indicates a feed roller advancing the paper.

When it is intended to load the roll-type paper 130 in the printer main body 10, as shown in FIG. 7, the locking latch 60 is first released and the cover frame 20 pivots to be lifted from the printer main body 10. As a result, the paper loading space 15 in the printer main body 10 is exposed so that the user can easily load the paper in the paper loading space 15 through a drop-in method. Then, a front end of the paper 130 is pulled to be drawn toward the printer head 12. As the cover frame 20 is closed and then moves downward, the rear portion of the platen 30 remains biased rearward by the elastic member 45 until the supporting members 52a and 52b are supported on the base members 54a and 54b.

Before the cover frame 20 is completely coupled to the printer main body 10, the supporting members 52a and 52b contact first the base members 54a and 54b to be supported thereon. As a result, the rear portion of the platen 30 is lifted while expanding the springs of the elastic member 45. That is, the platen 30 pivots counterclockwise. As a result, as shown in FIG. 8, the front plate member 36 of the platen 30 urges the paper 130 to the printer head 12 and the ribbon 122. In the course of this process, since the base members 54a and 54b are preset to be elevated up to a height where the printing operation is possible, the platen 30 pivots within a range in which the platen 30 is elevated by the base members 54a and 54b. As a result, the gap T between the platen 30 and the printer head 12 maintains a predetermined value such that the platen 30 can reach the printable position.

By the above-described operation, after the paper is loaded, as the cover frame 20 is closed, the platen 30 pivots toward the printer head 12 to urge the paper 130 to the printing position. That is, the disposition of the paper 130 between the printer head 12 and the platen 30 between which the ribbon 122 is disposed can be reliably realized.

According to another feature of the present invention, when the paper 130 is jammed between the printer head 12 and the platen 30, the jammed paper can be easily removed by simply opening the cover frame 20 from the printer main body 10.

That is, when the user releases the locking latch 60, the cover frame 20 is lifted by the returning operation of the springs to their initial states.

That is, since the springs are in their expanded states in a state where the supporting members 52a and 52b of the platen 30 is supported on the base members 54a and 54b, when the locking latch 60 is released, the expanded springs of the elastic member 45 are returned to their initial states to lift the cover frame 20 from the printer main body 10 and to pull the platen 30 rearward away from the printer head by the pivotal motion in the clockwise direction, as shown in FIG. 7.

The above-described operation is realized as the supporting members 52a and 52b move from the upper portion of the cutting slits 28 to the lower portion of the cutting slits 28. As a result, the cover frame 20 is elastically lifted from the printer main body 10 and the platen 30 pivots away from the head 12, the ribbon 122 and the paper 130, avoiding the confliction with peripheral components. When the cover frame 20 is separated from the printer main body 10, the user further lifts the cover frame 20 to remove the jammed paper and exchange the paper.

According to the present invention, by providing the platen adjusting unit 40 allowing the platen 30 to pivot, the jammed paper removal and the paper exchange can be easily performed.

Furthermore, since the loaded paper 130 can be reliably positioned to the printing position between the printer head 12 and the platen 30, between which the ribbon 122 is located, by the pivotal motion of the platen 30, the printing quality can be improved.

Since the structure of the platen adjusting unit 40 is simple, the printer can be inexpensively manufactured while improving the printing quality.

It will be apparent to those skilled in the art that various modifications and variations can be made in the present invention. Thus, it is intended that the present invention covers the modifications and variations of this invention provided they come within the scope of the appended claims and their equivalents.

1. A printer for printing on a recording medium in accordance with date received from a host device, comprising:
a printer main body having a printer head;
a cover frame pivotally connected to the printer main body, the cover frame having an end on which a platen is mounted; and
a platen adjusting unit for allowing the platen to pivot away from the printer head when the cover frame is opened, and for allowing the platen to pivot close to the printer head with a predetermined gap between the platen and the printer head when the cover frame is closed.

2. The printer of claim 1, wherein the platen adjusting unit comprises:
a pivot shaft pivotally fixing the platen on the cover frame;
an elastic member providing a pivotal motion of the platen around the pivot shaft; and
a gap maintaining unit for returning the platen to an initial position to maintain the predetermined gap between the platen and the printer head when the cover frame is closed on the printer main body.

3. The printer of claim 2, wherein the platen is designed having a bent section so that the pivot shaft can be mounted on the platen, the platen being provided at a surface facing the printer head with a plate member through which the pivot shaft is inserted, opposite ends of the pivot shaft being fixed by penetrating the cover frame, thereby pivotally fixing the platen to the cover frame.

4. The printer of claim 2, wherein the elastic member is formed of a spring disposed in the platen, and having first and second ends respectively hooked on a projection of the platen and a projection of the cover frame to elastically support the platen.

5. The printer of claim 2, wherein the gap maintaining unit comprises supporting members extending from the platen over a slit formed of the cover frame and base members extending from the printer main body to support the supporting members at a predetermined height.

6. The printer of claim 5, wherein a height of the base members is preset to define a position of the supporting members, thereby allowing the platen reaches a predetermined gap with respect to the printer head in the course of a pivotal motion of the platen.

7. The printer of claim 6, wherein the gap is determined such that the printing is realized by allowing the platen to support the paper.

8. The printer of claim 4, wherein the spring of the elastic member is designed to lift the cover frame and to allow the platen to pivot away from the printer head when the cover frame is opened.
